(19) United States
(12) Patent Application Publication
(10) Pub. No.: US 2010/0195863 A1
(43) Pub. Date: Aug. 5, 2010

(54) SPEAKER

(75) Inventors: Kenta Fujimoto, Tendo (JP); Teruaki Kaiya, Tendo (JP); Daisuke Itoh, Tendo (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Meguro-ku, Tokyo (JP)

(21) Appl. No.: 12/446,012

(22) PCT Filed: Nov. 17, 2006
(86) PCT No.: PCT/JP2006/323026

§ 371 Date: Apr. 17, 2009

(51) Int. Cl. H04R 1/00

(52) U.S. Cl. 381/409

(57) ABSTRACT

A speaker having a drive cone and a diaphragm which can deal with higher output. The speaker comprises a frame, a magnetic circuit section, and a vibrating section. The magnetic circuit section is fixed to the frame. The vibrating section is housed in the frame and includes a drive cone (14) and a diaphragm (15) which are vibrated by the magnetic circuit section. The drive cone (14) has a coniacal cone body (47), outer steps (48) and inner steps (49). A plurality of outer steps (48) are provided at the outer edge of the cone body (47) while spaced apart along the circumferential direction. A plurality of inner steps (49) are provided at the inner edge of the cone body (47) while spaced apart along the circumferential direction. The steps (48, 49) are formed flatly along the vibrating direction of the drive cone (14), i.e. the direction intersecting the central axis perpendicularly. A gold thread (36) is secured to each of the steps (48, 49).

### TECHNICAL FIELD

This invention relates to a speaker for generating sound by vibrating a drive cone with a speech current supplied.

### BACKGROUND

Various speakers have been equipped in motor vehicles as disclosed in, for example Patent Document 1. The speaker described in the Patent Document 1 includes a frame, a vibration portion, and a magnetic circuit. The vibration portion is received in the frame. The magnetic circuit is attached to the frame and generates sound by vibrating the vibration portion.

The vibration portion includes a voice coil for supplying speech current, a voice coil bobbin of which the voice coil is coiled around an outer circumference, a drive cone attached to the voice coil bobbin, and a diaphragm attached to the drive cone. The exterior of drive cone is formed into a cone shape and sheet like shape. The magnetic circuit includes a permanent magnet. The voice coil is arranged in the magnetic gap.

In the speaker described above, when the speech current is supplied to the voice coil, electromagnetic force (Lorentz force) affects in the voice coil, and the diaphragm is vibrated through the drive cone. Thereby, the speaker generates sound responsive to the speech current.

[Patent Document 1] Japanese Application for utility model registration No. S63-158091

### DISCLOSURE OF THE INVENTION

### Problem to be Solved by the Invention

In the speaker described in the Patent Document 1, the drive cone is formed into a gently sloping cone shape so as to reduce the thickness of the speaker. In recent years, a speaker for playing sound at full blast (hereafter, high power output) is required in a speaker mounted in motor vehicles. In order to respond to the high power output, it is necessary to form the drive cone into a sharply sloping cone shape.

However, when the speaker is played at full volume, amplitude of the drive cone increases. Thereby, the drive cone requires more mechanical strength. As shown in the Patent Document 1 described above, when the drive cone is formed into a thin plate shape, it is difficult to maintain mechanical strength which is required for the high power output.

It is an object of the present invention to provide a speaker having a drive cone or a diaphragm which can correspond to the high power output more.

### Means for Solving Problem

According to a first aspect of the present invention, a speaker includes a frame, a magnetic circuit attached to the frame, and a vibration portion. The vibration portion has a voice coil accepting a speech current, a diaphragm and a drive cone. The drive cone is formed into a cone shape, and transmits a vibration of the voice coil to the diaphragm. A step portion which is flat along a direction perpendicular to a vibration direction of the drive cone is provided on the drive cone.

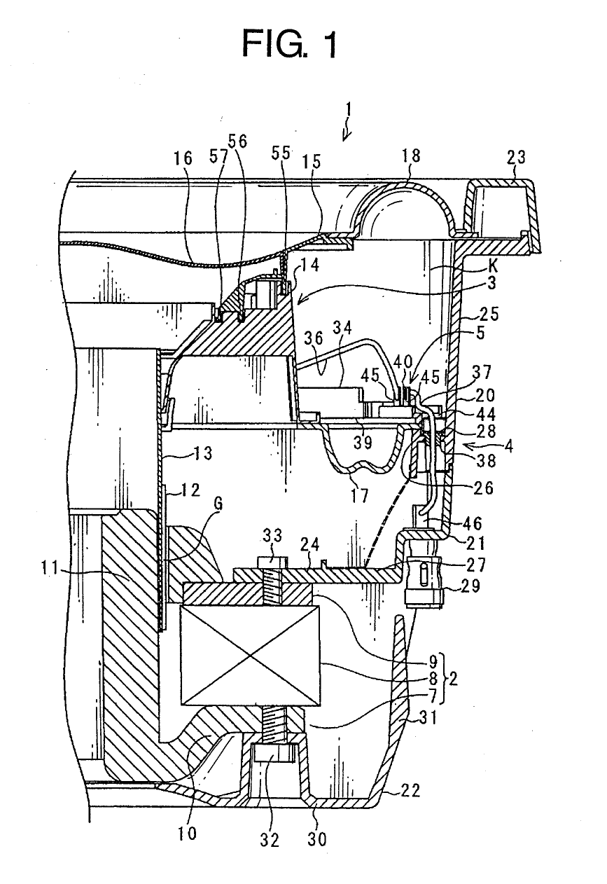

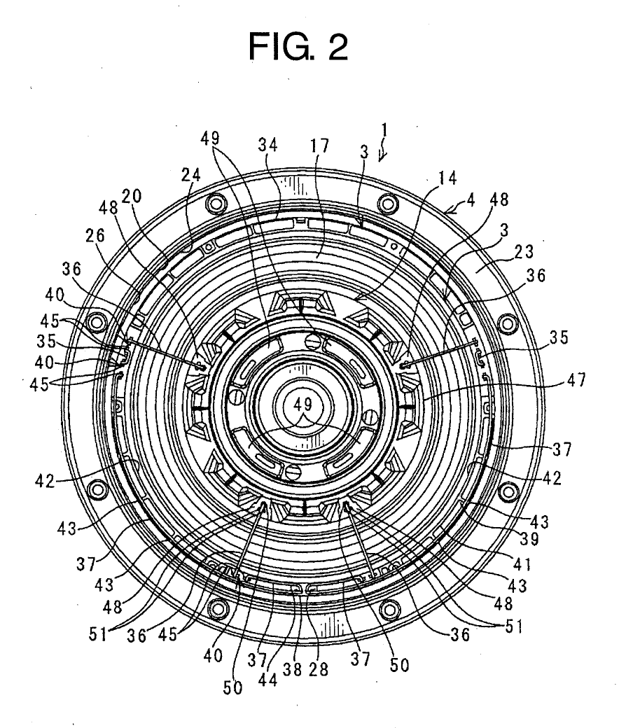

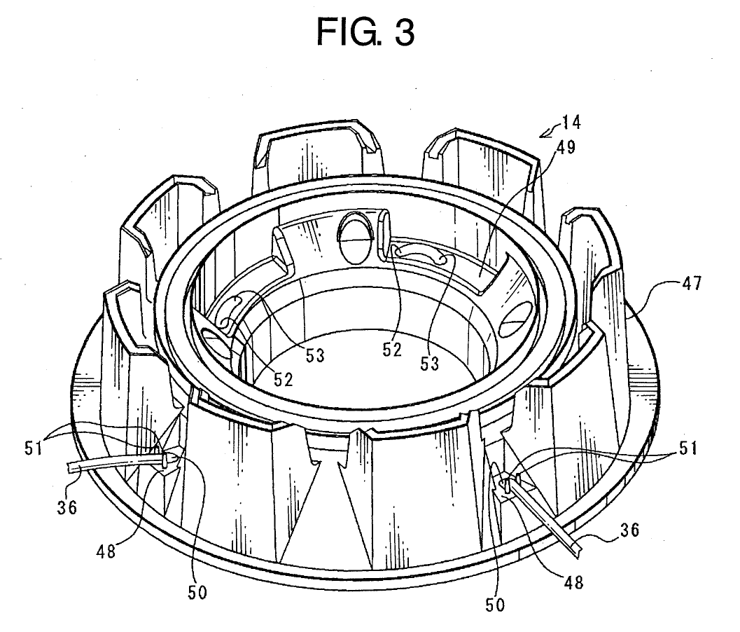

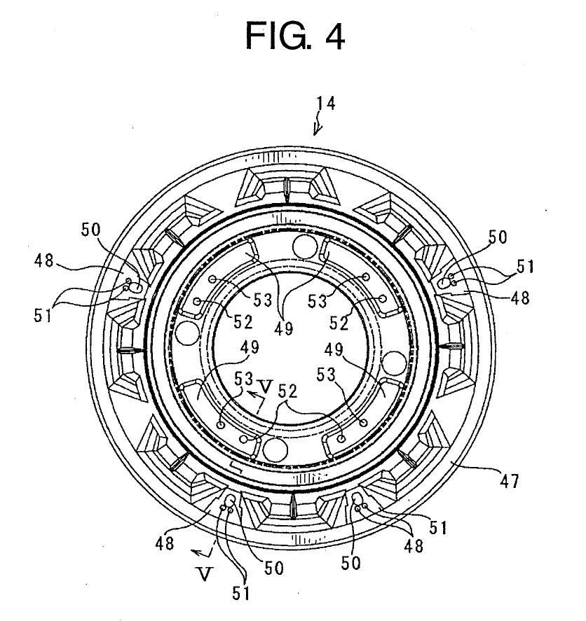

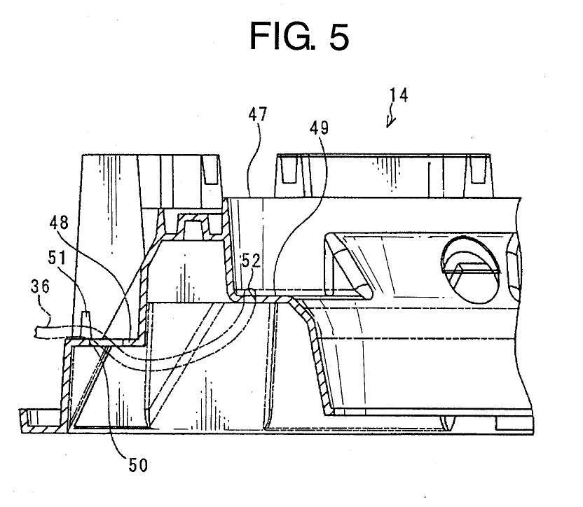

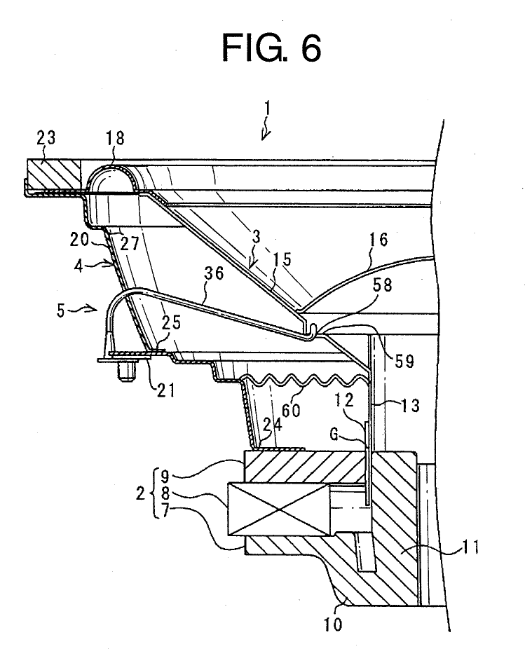

### BRIEF DESCRIPTION OF DRAWINGS

[FIG. 1] A sectional view showing an embodiment of a speaker according to the present invention.

[FIG. 2] A front view showing a condition removing a diaphragm of the speaker or a center cap shown in FIG. 1.

[FIG. 3] A perspective view seeing the drive cone of the speaker shown in FIG. 1 from a back side.

[FIG. 4] A plan view seeing the drive cone shown in FIG. 3 from the back side.

[FIG. 5] A sectional view taken along section V-V of FIG. 4.

[FIG. 6] A sectional view showing a second embodiment of a speaker according to the present invention.

### EXPLANATIONS OF LETTERS OR NUMERALS

1 speaker
2 magnetic circuit
3 vibrating part
4 frame
12 voice coil
14 drive cone
15 diaphragm
36 tinsel wire
48 outside step portion (step portion)
49 inside step portion (step portion)
50 through hole
51 fixing pin (holding portion)
52 through hole
53 fixing hole (holding portion)
58 through hole
59 step portion
60 damper
K space

### BEST MODE FOR CARRYING OUT THE INVENTION

Hereafter, a first embodiment of the present invention is explained. In a speaker of the embodiment of the present invention, a step portion which is flat in a direction perpendicular to a vibration direction is provided on the drive cone. Thereby, the speaker of the present invention improves mechanical strength of the drive cone. For this reason, the speaker can provide the drive cone with adequate mechanical strength against the high power output. Therefore, the speaker corresponding to the high power output can be provided.

Also, the speaker may fix a tinsel wire on the step portion. In this case, when the tinsel wire is fixed with glue in assembling, the glue fixes securely on the step portion. Thereby, the tinsel wire can be assuredly fixed on the drive cone.

Furthermore, the step portion fixing the tinsel wire may be arranged on both an inner edge of the drive cone and an outer edge of the drive cone. In this case, the tinsel wire can be fixed on the inner edge and the outer edge of drive cone. Thereby, even if the speaker is played at full volume, the tinsel wire does not come away from the drive cone. That is, the tinsel wire can be prevented from falling off from the drive cone.

It is preferable to arrange the step portion fixing the tinsel wire in a circumferential direction of the drive cone at intervals. In this case, when force is applied to the drive cone from the tinsel wire, weight balance of the drive cone becomes equal. Thereby, vibration of the drive cone can be prevented from exerting a bad affect by the tinsel wire. In addition, by equalizing the weigh balance of the drive cone, weigh balance of the vibrating part can be equalized.

In the speaker of the present invention, air of a space sealed between the drive cone and a diaphragm is generated, and is used as spring characteristic of air spring. The spring characteristic as the air spring absorbs vibration energy of voice coil bobbin and the diaphragm, and reduces a vibration of their voice coil bobbin. For this reason, a damper arranged on a conventional speaker is not required. Therefore, construction of the speaker can be simplified.

### Embodiment

A first embodiment of the present invention is explained by referring to FIGS. 1-5. A speaker 1 of the first embodiment shown in FIG. 1 is equipped in a vehicle such as a motor vehicle and provides sound information to a passenger.

As shown in FIG. 1, the speaker 1 includes a frame 4, a magnetic circuit 2, a vibration portion 3 generating sound, and a wiring structure 5.

As shown in FIG. 1, the frame 4 includes a frame body 20, a connecter frame 21, a cover 22 for magnetic circuit, and a gasket 23.

The frame body 20 is made of metal such as aluminum. The frame body 20 includes a bottom portion 24 of a ring shape, a cylindrical cylinder 25 projecting from an outer edge of the bottom portion, and a flange 26 projecting from an inner surface of the cylinder 25. In one end of the cylinder 25 on the bottom portion 24, an opening 27 passing through the cylinder 25 (that is, the frame body 20) is arranged. A plurality of the openings 27 is arranged in a circumferential direction of the frame body 20 at intervals

The flange 26 is formed into a ring shape, and projects from the inner surface of the cylinder 25 toward an inner side of the cylinder 25. The flange 26 is arranged along the inner surface of the cylinder 25 and all around an inner edge portion of the cylinder 25. In the flange 26, a hole 28 is arranged. A tube member 38 described below is pressed in the hole 28. The hole 28 passes through the frame body 20 of the frame 4. That is, the hole 28 passes through the flange 26.

The connecter frame 21 blocks the opening 27 of the frame body 20, and is attached to the frame body 20. A connector 29 is attached to the connector frame 21. The connector 29 can connect to an amplifier mounted in a vehicle. The connector 29 may connect to another electric device.

The cover 22 for magnetic circuit includes an annular bottom portion 30, a tube 31 upstanding from an outer edge of the bottom portion 30. The cover 22 for magnetic circuit is fixed on a yoke 7 of the magnetic circuit 2 by a bolt 32. Furthermore, a plate 9 and the frame body 20 are fixed by a bolt 33. When the cover 22 for magnetic circuit is fixed in the frame body 20, the cover 22 and the frame body 20 are coaxially arranged. That is, central axes of the cover 22 and the frame body 20 are same.

The gasket 23 is formed into a ring shape. The gasket is overlapped with an outer edge portion (an outer circumference portion) of the frame body 20. The gasket 23 sandwiches an edge 18 with the outer edge portion, and is fixed in the frame body 20 with glue. Also, the gasket 23 sandwiches the edge 18 between the outer edge portion of the frame body 20, and fixes a diaphragm 15 described below in the frame body 20.

The magnetic circuit 2 is fixed in both the cover 22 and the frame body 20, and attached to the frame 4. As shown in FIG. 1, the magnetic circuit 2 includes the yoke 7, a magnet 8, and the plate 9. The yoke 7 is formed from a magnetic material such as paramagnetic or ferromagnetic material. The plate 9 is formed from a magnetic material such as paramagnetic or ferromagnetic material. The yoke 7 includes an annular bottom plate 10 and a cylindrical center pole 11 upstanding from an inner edge of the bottom plate 10. In this embodiment, magnetic circuit of outer magnet type is disclosed. However, it is possible to apply the present invention to various magnetic circuits (for example, inner magnet type or combination of inner and outer magnet type, that is, magnetic circuit arranging magnet in an inside and outside of voice coil bobbin). Furthermore, an opening leading into an outside of a speaker device is formed in the center pole in the embodiment but not limited thereto.

The magnet 8 is formed into a ring shape. An inner diameter of the magnet 8 is larger than an outer diameter of the center pole 11. The magnet 8 is superposed on the bottom plate 10 and allows the cylindrical center pole 11 to pass therethrough. The magnet 8 may be excited with a permanent magnet or a direct current.

The plate 9 is formed into a ring shape. An inner diameter of the plate 9 is larger than an outer diameter of the center pole 11. The plate 9 is superposed on the magnet 8 and allows the center pole 11 of the yoke 7 and a voice coil bobbin 13 to pass through the center portion thereof. The yoke 7, magnet 8, and plate 9 are coaxially disposed to each other. Inner surfaces of the magnet 8 and plate 9 have a space against an outer surface of the center pole 11 of the yoke 7.

The yoke 7 is fixed in the cover 22 for magnetic circuit by the bolt 32 passing through the bottom portion 30 and the bottom plate 10. Also, the plate 9 is fixed on the frame body 20 by screwing the bolt 33 passing through the bottom portion 24 of the frame body 20 thereto. Therefore, since the plate 9 is fixed on the frame body 20 and the bottom plate 10 is fixed in the cover 22 for magnetic circuit, the magnetic circuit 2 is fixed on the frame 4. The yoke 7, magnet 8, and plate 9 are coaxial with the frame 4.

The magnetic circuit 2 has a magnetic gap G between the outer surface of the center pole 11 of the yoke 7 and the inner surface of the plate 9. The magnetic gap G has a large magnetic flux density. That is, the magnetic circuit 2 vibrates the drive cone 14, 15 by generating electromagnetic force (Lorentz force) with the voice coil 12 in the magnetic gap G.

The vibration portion 3 is received in the frame body 20 of the frame 4. The vibration portion 3 includes a voice coil 12, the voice coil bobbin 13, a drive cone 14, the diaphragm 15 and a center cap 16. In the embodiment, two voice coils 12 are included, and two voice coil bobbins 13 are winded together (not shown). The two voice coils 12 are coaxially arranged each other before the diaphragm 15 is driven, and placed in the magnetic gap G of the magnetic circuit 2. Speech current is supplied to the two voice coils 12.

The voice coil bobbin 13 has a tube shape. An inner diameter of the voice coil bobbin 13 is larger than the outer diameter of the center pole 11 of the yoke 7. An outer diameter of the voice coil bobbin 13 is smaller than the inner diameter of the plate 9 and magnet 8. The voice coil bobbin 13 is coaxial with the yoke 7, the plate 9 and voice coil 12. One end portion of the voice coil bobbin 13 is inserted in the magnetic gap G, and attached with the voice coil 12 around an outer surface of the one end. The voice coil bobbin 13 is movably supported with the drive cone 14 and the diaphragm 15 along an axis of the yoke 7. The axis of the yoke 7 is also the axis of the speaker 1.

The drive cone 14 transmits vibration of the voice coil 12 to the diaphragm 15. The drive cone 14 is formed with a synthetic resin. The drive cone 14 is formed into a cone shape. An inner edge of the drive cone 14 is attached to an outer surface of the other end in a central axis direction of the voice coil bobbin 13. Thereby, the drive cone 14 is attached to the voice coil 12 through the voice coil bobbin 13.

As shown in FIGS. 3 and 4, the drive cone 14 has integrally a cone body 47, a plurality of outside step portions 48, and a plurality of inside step portions 49. The cone body 47 is formed into a cone shape. The outside step portion 48 and the inside step portion 49 are a step portion which is flat along a direction perpendicular to a vibration direction of the drive cone 14. The outside step portion 48 and the inside step portion 49 are provided with the same number of tinsel wires 36 described below. That is, in FIG. 2, the four tinsel wires are arranged. The outside step portion 48 and the inside step portion 49 respectively corresponds to the tinsel wire 36 one to one.

The outside step portion 48 and the inside step portion 49 are provided along a vibration direction of the drive cone 14. That is, the outside step portion 48 and the inside step portion 49 are formed in a direction perpendicular to a central axis. The outside step portions 48 are arranged at intervals around the drive cone 14 of the speaker 1. Also, the inside step portions 49 are arranged at intervals around the drive cone 14 of the speaker 1. The outside step portion 48 is arranged on an outer edge of the cone body 47 of the drive cone 14. The plurality of outside step portions 48 are respectively arranged along the circumferential direction of the cone body 47 of the drive cone 14.

The outside step portion 48 has a through hole 50 and a pair of fixing pins 51 as a holding portion. The through hole 50 is arranged in the center of the outside step portion 48. As shown in FIG. 5, the through hole 50 passes through the center of the outside step portion 48, and goes the tinsel wire 36 through an inside. The pair of fixing pins 51 project from the outside step portion 48 toward the diaphragm 15. The through hole 50 is arranged near the fixing pin 51. The tinsel wire 36 passing through the through hole 50 is sandwiched between the fixing pins 51. Thereby, the pair of the fixing pins 51 fixes the tinsel wire 36 in the outside step portion 48. That is, the tinsel wire 36 is fixed on the drive cone 14.

The inside step portion 49 is arranged on an inner edge of the cone body 47 of the drive cone 14. The plurality of inside step portions 49 are respectively arranged along the circumferential direction of the cone body 47 of the drive cone 14.

As shown in FIG. 4, a through hole 52 and fixing hole 53 as a holding portion is arranged on the inside step portion 49. The through hole 52 is arranged on one end near the outside step portion 48 corresponding to the inside step portion 49. As shown in FIG. 5, the through hole 52 passes through one end of the inside step portion 49, and threads the tinsel wire 36 through an inside. The fixing hole 53 passes through the center of the inside step portion 49, and is arranged in concurrence with the through hole 52 along the circumferential direction. Furthermore, the fixing hole 53 passes through a terminal of the tinsel wire 36 passed through the through hole 52, and fixes the tinsel wire 36 in the inside step portion 49. That is, the tinsel wire 36 is fixed in the drive cone 14.

In an outer edge of the drive cone 14, an edge 17 is attached with glue. The edge 17 is formed into an annular and flat shape, and deformable. Connection of the edge 17 and the drive cone 14 can use known means such as a screwing or sewing method except the glue. The edge 17 is sandwiched between the flange 26 of the frame body 20 and a positioning member 34 of the wiring structure 5, and fixed by them. That is, the drive cone 14 is attached to the frame body 20 in the frame 4 through the edge 17.

The diaphragm 15 is made of a synthetic resin, and formed into a ring shape. An inner diameter of the diaphragm 15 is larger than an inner diameter of the drive cone 14, and an outer diameter of the diaphragm 15 is larger than an outer diameter of the drive cone 14. The diaphragm 15 is fixed in a part of the drive cone 14 and grooves 55, 56, 57 shown in FIG. 1 with glue. In an outer edge of the diaphragm 15, the edge 18 is attached with glue. A cross section shape of the edge 18 is formed into a semicircle and sheet-like shape. The outer edge of the edge 18 is sandwiched between the outer edge of the cylinder 25 of the frame body 20 and the gasket 23, and fixed on the cylinder 25 and the gasket 23. That is, the diaphragm 15 is attached to the frame body 20 of the frame 40 through the edge 18.

The center cap 16 is made of a synthetic resin, and formed into a circular shape. A central portion of a cross section shape of the center cap 16 projects toward an acoustic radiation direction. Also, the central portion is formed into a concave shape from the center portion toward the outer edge. An outer diameter of the center cap 16 is larger than the inner diameter of the drive cone 14 and is smaller than the outer diameter of the diaphragm 15. The outer edge of the center cap 16 is superposed on the diaphragm 15, and attached to the diaphragm 15 with glue all around the outer edge.

The drive cone 14 of the vibration portion 3, the diaphragm 15 and the center cap 16 are coaxially disposed to the frame 4 and the magnetic circuit 2. When the current (speech current) depending on sound information is supplied to the voice coil 12, the vibration of the voice coil 12 is transmitted to the diaphragm 15 by the drive cone 14. And then, the diaphragm 15 vibrates along the central axis, and the vibration portion 3 generates sound according to the speech current.

A space K surrounded with the drive cone 14, the diaphragm 15, the edges 17, 18 and the inner surface of the frame body 20 of the frame 4 is sealed. That is, the space K is kept with airtight condition.

Thereby, in the vibration portion 3, the voice coil bobbin 13 vibrates along a central axis direction. When the drive cone 14 and the diaphragm 15 vibrate, the drive cone 14, the diaphragm 15 and the edges 17, 18 are displaced. Thereby, air in the space K between the drive cone 14 and the diaphragm 15 repeats compression and expansion. As a result, spring characteristic as an air spring is generated.

In the embodiment, when effective area of the diaphragm 15 is S1 and effective area of the drive cone 14 is S2, difference S of effective area is S=S1−S2. Furthermore, when volume of air in the space K between the drive cone 14 and the diaphragm 15 is V, stiffness constant expressing the spring characteristic of air spring is proportional to S/V. That is, in the embodiment, the air of the space K sealed between the drive cone 14 and the diaphragm 15 is generated. And then, the air is used as the spring characteristic as the air spring. Thereby, abnormal movement (for example, the diaphragm 15 operates with very large amplitude) can be controlled. Furthermore, acoustic characteristics of the speaker 1 can be continuously reproduced, and be played over long periods. Also, reliability of the speaker 1 can be maintained even if the diaphragm 15 vibrates over long periods with large amplitude.

As shown in FIG. 2, the wiring structure includes the positioning member 34, a fuse 35, a plurality of tinsel wires 36, a plurality of lead wires 37 and a tube member 38. The positioning member 34, as shown in FIG. 2, has a member body 39 and a press contact terminal 40. A part of the press contact terminal 40 is molded into the member body 39. An outer diameter of the member body 39 is formed into a ring shape, and is approximately equal in size to the inner diameter of the cylinder 25 of the frame body 20. The member body 39 has a bottom plate 41, a plurality of inner walls 42, and a plurality of positioning pins 43. The bottom plate 41 is superposed on the flange 26. The plurality of inner walls 42 projects from an inner edge of the bottom plate 41, and have spaces along the circumferential direction. The plurality of positioning pins 43 projects from a center of radial direction of the bottom plate 41, and have spaces along the circumferential direction.

The bottom plate 41 of the positioning member 34 of the member body 39 sandwiches an outer edge of the edge 17 with the flanges 26, and the positioning member 34 of the member body 39 is fixed on the flange 26 of the frame body 20 with a bolt or glue not shown. Thereby, the positioning member 34 of the member body 39 is arranged in the space K. The inner wall 42 and the positioning pin 43 sandwich the lead wire 37 between each other, and determine a position of the lead wires 37 along an inner surface of the cylinder 25 of the frame body 20 of the frame 4. That is, the positioning member 34 determines the position of the lead wires 37 along the inner surface of the cylinder 25 of the frame body 20 in the frame 4. In the member body 39, as shown in FIG. 1, when the member body 39 is attached to the flange 26, a cutout portion 44 overlapping with the hole 28 is provided.

The press contact terminal 40 is formed from a conductive metal plate, and has integrally a pair of pressure welding blades 45 upstanding from the member body 39 and a connection portion not shown. The connection portion connects with the pair of pressure welding blades 45 and is buried in the member body 39. In the press contact blade 45 of the press contact terminal 40, the tinsel wire 36 or the lead wire 37 is inserted.

In the FIG. 2, the six pressure welding terminals 40 are provided, and arranged at regular intervals in the circumferential direction of the member body 39. When the positioning member 34 is fixed in the frame 4, two of the six pressure welding terminals 40 are arranged near the hole 28. The other four are arranged away from the hole 28.

In FIG. 2, the two fuses 35 are provided. As shown in FIG. 2, the fuse 35 is inserted into the pressure welding blade 45 of the pressure welding terminal 40 coming close to each other, which is one of the other four pressure welding terminals 40 arranged away from the hole 28. The pressure welding terminals 40 coming close to each other are connected with the fuse 35. Therefore, the fuse 35 is arranged in the space K. The fuse 35 is connected to the lead wire 37 and the tinsel wire 36 in series. When the speech current supplied to the voice coil 12 exceeds a predetermined current value, the fuse 35 blows out. Thereby, supply to voice coil 12 from the speech current is stopped.

In FIG. 2, the two tinsel wires 36 are provided. One end of the tinsel wire 36 is passed through the through hole 50 provided on the outside step portion 48 from an inside of the frame body 20 of the drive cone 14. Thereafter, the one end of the tinsel wire 36 is passed through the through hole 52 arranged on the inside step portion 49 and the fixing hole 53 in turn. And then, the tinsel wire 36 is connected to a top portion of the voice coil 12. In this time, the tinsel wire 36 is sandwiched between the pair of the fixing pins 51 provided on the outside step portion 48, and is fixed in the outside step portion 48. Glue including such as a silicon rubber is filled around the tinsel wire 36, the through holes 50, 52 and the fixing hole 53. The space therebetween is sealed. The tinsel wire 36 is fixed on the drive cone 14 with the glue.

Since the tinsel wire 36 is fixed in the outside step portion 48 and the inside step portion 49, the tinsel wire 36 have spaces along the circumferential direction of the drive cone 14. Furthermore, the tinsel wire 36 is pulled out from outer surfaces of the voice coil bobbin 13 and the drive cone 14 toward the positioning member 34 (that is, space K) along the radial direction of the speaker 1.

Each of the two tinsel wires 36 is pressed into the press contact blade 45 provided away from the hole 28 of the pressure of welding terminal 40, which is one of the four pressure welding terminals 40 arranged away from the hole 28. The other two tinsel wires 36 are pressed into the press contact blade 45 provided away from the hole 28 of the press contact terminal 40, which is one of the other two pressure welding terminals 40 arranged near the hole 28, and connected to the press contact terminal 40.

The lead wire 37 is a covered electric wire having a conductive core and a covering portion of insulation. In Figs, the four lead wires 37 are provided. The two lead wires 37 are pressed into the press contact blade 45 near the hole 28 of the pressure of welding terminal 40, which is one of the four pressure welding terminals 40 arranged away from the hole 28, and connected to the press contact terminal 40. The other two lead wires 37 are pressed into the press contact blade 45 near the hole 28 of the press contact terminal 40, which is one of the other two pressure welding terminals 40 arranged near the hole 28, and connected to the press contact terminal 40.

Thereby, the lead wire 37 is connected to the voice coil 12 through the press contact terminal 40 and the tinsel wire 36. On condition that the lead wire 37 is sandwiched between the inner wall 42 and the positioning pin 43 and positioned, the lead wire 37 is wired from the press contact blade 45 toward the cutout portion 44 (that is, toward the hole 28). The lead wire 37 supplies the speech current to the voice coil 12.

The tube member 38 is made of rubber, and formed into a cylindrical shape. The tube member 38 may be made of synthetic resin material. The tube member 38 is molded by insert molding so that the rubber is covered around the four lead wires 37 respectively. The tube member 38 passes all of four lead wires 37 through inside, and the four lead wires 37 are bound. And then, the tube member 38 is pressed into the hole 28, and attached to the frame body 20 of the frame 4. The tube member 38 passes all of the four lead wires 37 through inside, and leads the four lead wires 37 to an outside of the space K. The lead wire 37 is attached to a terminal 46 of the connector 29 in the outside of the space K. When the drive cone 14 and the diaphragm 15 vibrate, the tube member 38 keeps in air tight condition so as to prevent air of the space K from leaking out of the space K through the hole 28. In order to keep the space K in air tight, it is preferred that the tube member 38 is made of elastic rubber.

The wiring structure 5 presses the fuse 35, the tinsel wire 36, and the lead wire 37 into the desired press contact blade 45, and inserts the tube member 38 passing through all of the four lead wires 37 into the hole 28. Thereby, the lead wire 37 is attached to the terminal 46 of the connector 29 and assembled.

The tinsel wire 36 is attached to the drive cone 14 as below on condition that the outside step portion 48 and the inside step portion 49 are parallel to a horizontal direction. The tinsel wire 36 is sandwiched between the pair of the fixing pins 51 provided on the outside step portion 48 of the drive cone 14 from the back of the frame body 20 beyond the drive cone 14, and is passed through the through hole 50. And then, the tinsel wire 36 is passed through the through hole 52 and the fixing hole 53 provided on the inside step portion 49 in turn. Thereafter, the tinsel wire 36 is fixed in the drive cone 14 by the glue filled around the through holes 50, 52 and the fixing hole 53. In this time, the glue seals spaces between the through holes 50, 52, the fixing hole 53 and the tinsel wire 36. The spaces between the through holes 50, 52, the fixing hole 53 and the tinsel wire 36 are kept with airtight condition.

The wiring structure 5 connects the lead wire 37, the fuse 35, the tinsel wire 36 and the voice coil 12 in series, and supplies the speech current supplied to the terminal 46 of the connector 29 to the voice coil 12.

In the above speaker 1, the speech current is supplied to the voice coil 12 through the lead wire 37 of the wiring structure 5. According to the speech current, the voice coil 12 arranged in the magnetic gap G vibrates along the central axis. Furthermore, the voice coil bobbin 13 around the outer circumference of which the voice coil 12 is coiled thereof vibrates along the central axis with the drive cone 14 and the diaphragm 15. That is, vibration of the voice coil 12 is transmitted to the diaphragm 15 by the drive cone 14, and the diaphragm 15 vibrates. By vibrating the diaphragm 15, sound depending on the speech current is generated. In this way, the magnetic circuit 2 vibrates the diaphragm 15 (that is, the vibration portion 3) and generates sound.

In this embodiment, the step portion (that is, the outside step portion 48 and the inside step portion 49) which is flat in a direction perpendicular to a vibration direction of the drive cone 14 is arranged on the drive cone 14. Thereby, the mechanical strength of the drive cone 14 is improved. Additionally, the adequate mechanical strength against the high power output can be given to the drive cone 14. Therefore, the speaker 1 corresponding to the high power output can be provided.

The speaker 1 fixes the tinsel wire 36 in the outside step portion 48 and the inside step portion 49. Thereby, when the tinsel wire 36 is fixed with the glue in assembling, the glue fixes securely on the outside step portion 48 and the inside step portion 49 (that is, step portions). Therefore, the tinsel wire 36 can be assuredly fixed on the drive cone 14.

In addition, the outside step portion 48 and the inside step portion 49 which fix the tinsel wire 36 are provided on both the inner edge and the outer edge of the drive cone 14. Thereby, the tinsel wire 36 can be fixed in both the inner edge and the outer edge of the drive cone 14. Even if the speaker 1 is played at full volume, the tinsel wire 36 can be prevented from falling off the drive cone 14. That is, even if the high power output of the speaker 1 is performed, the tinsel wire 36 does not fall from the drive cone 14.

In this embodiment, a step portion 59 which is flat in a vibration direction of the voice coil 12 (that is, a direction perpendicular to the central axis) is arranged on the drive cone 14. Thereby, mechanical strength of the drive cone 14 is increased. That is, rigidity of drive cone 14 can increase by providing the step portion 59. As a result, adequate mechanical strength can be given to the drive cone 14 against the high power output. Therefore, the speaker 1 corresponding to the high power output can be provided. It is desirable to have a space in a circumferential direction of the drive cone 14 between the step portions (that is, the outside step portions 48 and the inside step portions 49) fixing the tinsel wire 36. In this case, when force acting on the drive cone 14 from the tinsel wire 36 is applied, weight balance of the drive cone 14 becomes equal. Thereby, vibration of the drive cone 14 can be prevented from negative effects of the tinsel wire 36. Furthermore, since weight balance of the drive cone 14 can be equalized, weight balance of the vibration portion 3 can be equalized.

In the speaker 1, air of space sealed between the drive cone 14 and the diaphragm 15 is generated, and is used as spring characteristic of air spring. The spring characteristic as the air spring absorbs vibration energy of the voice coil bobbin 13 and the diaphragm 15, and reduces vibration of their voice coil bobbin 13. For this reason, a damper arranged on a conventional speaker is not required. That is to say, in the speaker 1 of the embodiment, the drive cone 14 and the diaphragm 15 combine a damper decreasing vibrations of the drive cone 14 and the voice coil bobbin 13. Thereby, it is not necessary to equip the damper supporting the voice coil bobbin 13 behind the drive cone 14 and the diaphragm 15. Also, axial size of the speaker 1 can be reduced by omitting the damper and installation space thereof. Additionally, it is possible to produce a thin speaker required with an audio system mounted on a vehicle. Therefore, construction of the speaker 1 can be simplified.

The drive cone 14, which is concentrically equipped behind of the diaphragm 15 so as to maintain the sealed space K between the drive cone 14 and the diaphragm 15, may be made of material in common with the diaphragm 15. Thereby, comparing the speaker 1 of the present invention to the conventional speaker having a damper, mechanical fatigue is almost not generated in the speaker 1. Therefore, decreased reliability of a speaker device being caused by mechanical fatigue of components can be prevented, and the speaker 1 can be used for a long life.

Furthermore, in order to prevent lateral vibration (that is, movement of a perpendicular direction against a central axis of voice coil) of the diaphragm of the voice coil, the voice coil bobbin, or the drive cone, a damper having accordion structure (corrugation damper) deforms in the perpendicular direction against the central axis. However, in the drive cone 14 and the diaphragm 15, a large deformation is not locally caused. For this reason, peculiar vibration such as a rolling phenomenon causing a bad sound quality or rubbing sound, which is produced by the contact of the voice coil bobbin 13 with the plate 9 or the magnet 8, is not generated. Therefore, the speaker 1 can be played with high quality sound.

In the speaker 1, when the diaphragm 15 is vibrating, air of the sealed space K between the drive cone 14 and the diaphragm 15 repeats cycle of compression and expansion. Thereby, in the edges 17, 18 of the drive cone 14 and the diaphragm 15 deformation by air pressure (back pressure) receiving with a back surface thereof is not caused. As a result, the drive cone 14 and the diaphragm 15 can be vibrated with large amplitude without generation of the peculiar vibration or the rubbing sound described above. In addition, sound can be played at full volume. Furthermore, by the air spring in which the air of the space K is generated, the drive cone 14 and the edge 17 can control abnormal movement (for example, the diaphragm 15 operates with very large amplitude). Acoustic characteristics of the speaker 1 can be continuously reproduced, and be played over long periods. Also, reliability of the speaker 1 can be maintained even if the diaphragm 15 vibrates over long periods with large amplitude.

In the above embodiment, the two voice coils 12, the four tinsel wires 36, and the four lead wires 37 are provided. However, in the present invention, one or more than three voice coils 12 may be provided, and two or more than four tinsel wires 36 and lead wires 37 may be provided. Furthermore, as shown in the speaker 1 of second embodiment of the present invention shown in FIG. 6, the step portion 59 which is flat in a direction perpendicular to a vibration direction of the diaphragm 15 may be provided on the diaphragm 15. In this second embodiment shown in FIG. 6, for some elements same with those of the first embodiment, same reference numerals are used, and explanations are omitted. The speaker 1 shown in FIG. 6 includes the diaphragm 15 and a damper 60. The drive cone 14 is not included. In this second embodiment, one end of the damper 60 is fixed in the voice coil bobbin 13, and the other end is fixed in the frame body 20 of the frame 4. The step portion 59 which is flat in a direction perpendicular to a vibration direction of the diaphragm 15 is provided on the diaphragm 15. A through hole 58 and a holding portion not shown are provided on the step portion 59. The through hole 58 passes through the tinsel wire 36. The holding portion fixes the tinsel wire 36 on the step portion 59. The tinsel wire 36 passing through the through hole 58 is fixed on the holding portion. Thereafter, the tinsel wire 36 is fixed in the step portion 59 (That is, the diaphragm 15) with glue. As with the above first embodiment, the step portion 59 which is flat in a vibration direction (that is, a direction perpendicular to the central axis) is arranged on the diaphragm 15. Thereby, mechanical strength of the diaphragm 15 is increased. More specifically, by providing the step portion 59, rigidity of the diaphragm 15 can increase. For this reason, adequate mechanical strength can be given to the diaphragm 15 against the high power output. Therefore, the speaker 1 corresponding to the high power output can be provided.

The speaker 1 fixes the tinsel wire 36 in the step portion 59. Thereby, when the tinsel lead wire 36 is fixed with glue in assembling, the glue fixes securely on the step portion 59. Therefore, the tinsel wire 36 can be assuredly fixed on the diaphragm 15.

According to the above embodiments, the following speaker 1 is provided.

(Additional statement) The speaker 1 includes the frame 4, the magnetic circuit 2 attached to the frame 4, and the vibration portion 3. The vibration portion 3 has the voice coil 12 in which speech current is supplied, the diaphragm 15, and the drive cone 14. The drive cone 14 is formed into a cone shape, and transmits vibration of the voice coil 12 to the diaphragm 14. In the speaker 1, the step portions 48, 49 which are flat in a direction perpendicular to a vibration direction of the drive cone 14 are arranged on the drive cone 14.

According to the additional statement, the step portions 48, 49 which are flat in the vibration direction of the drive cone 14 (that is, in a direction perpendicular to the central axis) is arranged on the drive cone 14. Thereby, mechanical strength of the drive cone 14 is increased. For this reason, mechanical strength can be given to the drive cone 14 against the high power output. Therefore, the speaker 1 corresponding to the high power output can be provided.

The embodiment described above is only exemplary and the present invention is not limited thereto and includes any modification and alteration within the scope of the present invention.

1. A speaker comprising:
a frame;
a magnetic circuit attached to the frame; and
a vibration portion having a voice coil accepting a speech current, a diaphragm, and a cone-shaped drive cone transmitting vibration of the voice coil to the diaphragm;
wherein a step portion which is a flat along a direction perpendicular to a vibration direction of the drive cone is provided on the drive cone.

2. The speaker as claimed in claim 1, wherein a holding portion fixing a tinsel wire for supplying the speech current to the voice coil is provided on the step portion.

3. The speaker as claimed in claim 1, wherein a through hole is formed in the step portion, and the tinsel wire is passed through the through hole.

4. The speaker as claimed in claim 1, wherein the step portion is provided on both an outer edge of the drive cone and an inner edge thereof.

5. The speaker as claimed in claim 1, wherein a plurality of the step portions is spaced each other around the drive cone.

6. The speaker as claimed in any one of claims 1 to 5, wherein space surrounded by the frame, the drive cone and the diaphragm is sealed.

7. A speaker comprising:
a frame;
a magnetic circuit attached to the frame; and
a vibration portion having a voice coil accepting a speech current and a diaphragm;
wherein a step portion which is flat along a direction perpendicular to a vibration direction of the diaphragm is provided on the diaphragm.

8. The speaker as claimed in claim 7, wherein a holding portion fixing a tinsel wire for supplying the speech current to the voice coil is provided on the step portion.

9. The speaker as claimed in claim 7, wherein a through hole is formed in the step portion, and the tinsel wire is passed through the through hole.
